(19) United States
(12) Patent Application Publication
(10) Pub. No.: US 2012/0224766 A1
(43) Pub. Date: Sep. 6, 2012

(54) IMAGE PROCESSING APPARATUS, IMAGE PROCESSING METHOD, AND PROGRAM

(76) Inventors: Mitsuharu OHKI, Tokyo (JP); Tomonori MASUNO, Tokyo (JP); Satoru TAKEUCHI, Chiba (JP); Hiroaki TAKAHASHI, Tokyo (JP); Teppei KURITA, Tokyo (JP)

(21) Appl. No.: 13/404,997

(22) Filed: Feb. 24, 2012

(30) Foreign Application Priority Data
Mar. 4, 2011 (JP) 2011-047360

(51) Int. Cl. G06K 9/00; G06K 9/40; G06K 9/32

(52) U.S. Cl. 382/162; 382/293; 382/264

(57) ABSTRACT

An image processing apparatus includes a superimposition processing unit which performs a blend process on a plurality of images which are continuously photographed. The superimposition processing unit includes a moving subject detection unit, a blend processing unit, and a noise reduction processing unit. The moving subject detection unit detects the moving subject region of an image, and generates moving subject information in units of an image region. The blend processing unit generates a superimposition image by performing a blend process on the plurality of images using a high blend ratio in a stationary subject region and using a low blend ratio in the moving subject region based on the moving subject information. The noise reduction processing unit performs a stronger pixel value smoothing process on the moving subject region of the superimposition image based on the moving subject information.

### BACKGROUND

The present disclosure relates to an image processing apparatus, an image processing method, and a program. In particular, the present disclosure relates to an image processing apparatus, an image processing method, and a program which perform a process for reducing the noise and improving resolution of an image.

When an image process is performed on an image, such as a Noise Reduction (NR) process, a high resolution process which is called, for example, a Super Resolution (SR) process of generating a high-resolution image based on a low-resolution image, or the like, is performed, for example, the image process is applied to a plurality of images which include the same subject and which are continuously photographed. Meanwhile, the related art which discloses an image processing technology, such as noise reduction using a plurality of images, includes, for example, Japanese Unexamined Patent Application Publication No. 2009-194700 and Japanese Unexamined Patent Application Publication No. 2009-290827.

Japanese Unexamined Patent Application Publication No. 2009-194700 discloses an imaging apparatus which achieves the noise reduction by superimposing a plurality of images with reference to motion information between the images. In particular, Japanese Unexamined Patent Application Publication No. 2009-194700 discloses a method which removes the remaining noise in a portion in which there is a small number of images to be added. In detail, a process of changing the property of a noise removal filter based on the degree of addition is performed. The process is configured such that the number of additions is stored for each pixel, coring setting is made based on the number of additions after the addition is terminated, and then high frequency color noise is removed. However, there are problems in that a storage region which records the number of additions for each pixel is necessary, and in that the circuit size of the storage region increases as the number of additions and the number of pixels increase because it is necessary to prepare the coring setting according to the number of additions. Further, a noise removal process performed after the above-described addition is terminated has a problem of a circuit size in which a filter having a large number of taps is necessary when low frequency color noise is removed.

When the noise reduction process or the high resolution process is performed, the noise reduction and the high resolution are effectively realized using a larger number of images. Therefore, a memory which stores a large number of images is necessary for an apparatus which generates high-quality images.

However, a large number of image storage memories included in an image processing apparatus cause large-sized hardware and a high production cost. Therefore, there is a problem in that it is difficult to include such a plurality of memories in an imaging apparatus which is highly requested to reduce the size and the cost thereof.

Further, when a moving subject, that is, a moving subject region is present in an image, there are problems in that noise reduction effect is small even if a plurality of images is superimposed and, on the contrary, noise increases.

### SUMMARY

It is therefore desirable to provide an image processing apparatus, an image processing method, and a program which use a simplified hardware configuration, thereby enabling a noise reduction process and a high resolution process to be realized by performing a superimposition process using a plurality of images.

Further, it is desirable to provide an image processing apparatus, an image processing method, and a program which use a configuration in which a noise reduction process to which, for example, a Low Pass Filter (LPF) is applied is performed on a region which is estimated as a moving subject, thereby enabling an image having less noise to be generated in a moving subject region.

According to a first embodiment of the present disclosure, an image processing apparatus includes a superimposition processing unit which performs a blend process on a plurality of images which are continuously photographed. The superimposition processing unit includes a moving subject detection unit which detects the moving subject region of an image, and generates moving subject information in units of an image region; a blend processing unit which generates a superimposition image by performing a blend process on the plurality of images using a high blend ratio in a stationary subject region and using a low blend ratio in the moving subject region based on the moving subject information; and a noise reduction processing unit which performs a stronger pixel value smoothing process on the moving subject region of the superimposition image based on the moving subject information.

Further, in the image processing apparatus according to the first embodiment of the present disclosure, the noise reduction processing unit may perform a pixel value updating process in which a low-pass filter is applied.

Further, in the image processing apparatus according to the first embodiment of the present disclosure, the noise reduction processing unit may perform a pixel value updating process, in which a low-pass filter, having coefficients depending on the moving subject information which enables higher noise reduction effect to be obtained in the moving subject region, is applied.

Further, in the image processing apparatus according to the first embodiment of the present disclosure, the superimposition processing unit may include a Global Motion Vector (GMV) calculation unit which calculates the Global Motion Vector (GMV) of the plurality of images which are continuously photographed; and a position adjustment processing unit which generates a motion-compensated image by adjusting a subject position of a reference image into a position of a standard image based on the GMV. The moving subject detection unit may obtain the moving subject information based on a pixel difference of corresponding pixels between the motion-compensated image, obtained as a result of the position adjustment performed by the position adjustment processing unit, and the standard image. The blend processing unit may generate the superimposition image by blending the standard image and the motion-compensated image according to a blend ratio based on the moving subject information.

Further, in the image processing apparatus according to the first embodiment of the present disclosure, the moving subject detection unit may calculate the value α indicative of the moving subject information as the moving subject information in units of a pixel based on the pixel difference of the corresponding pixels between the motion-compensated image, obtained as the result of the position adjustment performed by the position adjustment processing unit, and the standard image. The blend processing unit may perform the blend process of setting the blend ratio of the motion-compensated image to be a low value with respect to a pixel which has the high possibility of being a moving subject and setting the blend ratio of the motion-compensated image to be a high value with respect to a pixel which has the low possibility of being the moving subject based on the value α.

Further, in the image processing apparatus according to the first embodiment of the present disclosure, the superimposition processing unit may include a high resolution processing unit which performs a high resolution process on a process target image, and the blend processing unit may superimpose high-resolution processed images using the high resolution processing unit.

Further, in the image processing apparatus according to the first embodiment of the present disclosure, the image processing apparatus may further include a GMV recording unit which stores the GMV of an image, which was calculated by the GMV calculation unit based on a RAW image, wherein the superimposition processing unit performs the superimposition process on a full-color image used as a process target using the GMV stored in the GMV recording unit.

Further, in the image processing apparatus according to the first embodiment of the present disclosure, the superimposition processing unit may be configured to perform a superimposition process by selectively inputting the RAW image or the brightness signal information of the full-color image as a process target image, and may be configured to perform a process of enabling an arbitrary number of image superimposition to be performed by sequentially updating data to be stored in a memory which stores two image frames.

Further, in the image processing apparatus according to the first embodiment of the present disclosure, the superimposition processing unit may perform a process of overwriting and storing an image, obtained after the superimposition process is performed, in the part of the memory, and uses the superimposition processed image stored in the corresponding memory for a subsequent superimposition process.

Further, in the image processing apparatus according to the first embodiment of the present disclosure, the superimposition processing unit may store pixel value data corresponding to each pixel of the RAW image in the memory and may perform the superimposition process based on the pixel value data corresponding to each pixel of the RAW image when the RAW image is used as the process target. Further, the superimposition processing unit may store brightness value data corresponding to each pixel in the memory and may perform the superimposition process based on the brightness value data corresponding to each pixel of the full-color image when the full-color image is used as the process target.

Further, according to a second embodiment of the present disclosure, an image processing method is executed by an image processing apparatus, and the image processing method includes performing a blend process on a plurality of images which are continuously photographed using a superimposition processing unit. The performing the blend process may include a moving subject detection process of detecting the moving subject region in an image and generating moving subject information in units of an image region; a blend process of generating a superimposition image by performing the blend process on the plurality of images using a high blend ratio in a stationary subject region and using a low blend ratio in the moving subject region based on the moving subject information; and a noise reduction process of performing a stronger pixel value smoothing process on the moving subject region of the superimposition image based on the moving subject information.

Further, according to a third embodiment of the present disclosure, a program causing an image processing apparatus to perform an image process, and the program causing a superimposition processing unit to perform a blend process on a plurality of images which are continuously photographed. The performing the blend process may include a moving subject detection process of detecting the moving subject region of an image and generating moving subject information in units of an image region; a blend process of generating a superimposition image by performing the blend process on the plurality of images using a high blend ratio in a stationary subject region and using a low blend ratio in the moving subject region based on the moving subject information; and a noise reduction process of performing a stronger pixel value smoothing process on the moving subject region of the superimposition image based on the moving subject information.

Meanwhile, the program according to the third embodiment of the present disclosure may be a program which can be provided using a storage medium and a communication medium provided in the computer readable format to for example, an information process apparatus or a computer system capable of executing various types of program codes. When such a program is provided in the computer readable format, processes may be realized on the information process apparatus or the program based on the computer system.

Further, other features, and advantages of the present disclosure will be clear based on the further detailed description with reference to embodiments of the present disclosure which will be described later and the accompanying drawings. Meanwhile, in the present specification, the system is the logical collective configuration of a plurality of apparatuses, and the apparatuses of each configuration are not limited to be included in the same case.

According to the configuration of the embodiments of the present disclosure, an apparatus and method which perform effective noise reduction on both moving subject region and stationary subject region are realized.

In detail, a superimposition processing unit, which performs a blend process on a plurality of images which are continuously photographed, is included. The superimposition processing unit detects the moving subject region of an image, generates moving subject information in units of an image region, generates a superimposition image by performing a blend process on the plurality of images using a high blend ratio in a stationary subject region and using a low blend ratio in the moving subject region based on the moving subject information, and performs a stronger noise reduction process on the moving subject region of the superimposition image based on the moving subject information. In the noise reduction process, for example, a pixel value updating process, in which a low-pass filter having coefficients depending on the moving subject information which enables higher noise reduction effect to be obtained in the moving subject region is applied, is performed.

An image on which noise reduction is performed on both of the moving subject region and the stationary subject region can be generated using the above-described processes.

### BRIEF DESCRIPTION OF THE DRAWINGS

FIG. 1 is a view illustrating an example of the configuration of an imaging apparatus which is an example of an image processing apparatus according to an embodiment of the present disclosure;

FIG. 2 is a view illustrating Bayer arrangement;

FIG. 3 is a flowchart illustrating a process performed by a superimposition processing unit;

FIG. 4 is a view illustrating an example of the configuration of a filter which is applied to a noise reduction processing unit;

FIG. 5 is a flowchart illustrating a process performed by the superimposition processing unit;

FIG. 6 is a view illustrating the configuration and the process of the superimposition processing unit which performs an image superimposition (blending) process on an input image (RAW image) from a solid-state imaging device;

FIG. 7 is a timing chart illustrating a process performed when the superimposition processing unit in FIG. 6 performs the superimposition process on the RAW image;

FIG. 8 is a view illustrating state transition performed when the superimposition processing unit in FIG. 6 performs the superimposition process on the RAW image;

FIG. 9 is a view illustrating state transition performed when the superimposition processing unit in FIG. 6 performs the superimposition process on the RAW image;

FIG. 10 is a view illustrating state transition performed when the superimposition processing unit in FIG. 6 performs the superimposition process on the RAW image;

FIG. 11 is a view illustrating the configuration and the process of the superimposition processing unit which performs an image superimposition (blending) process on an output image from a record reproduction unit;

FIG. 12 is a timing chart illustrating a process performed when the superimposition processing unit in FIG. 11 performs the superimposition process on a full-color image;

FIG. 13 is a view illustrating state transition performed when the superimposition processing unit in FIG. 11 performs the superimposition process on the full-color image;

FIG. 14 is a view illustrating the configuration and the process of the superimposition processing unit which includes a high resolution processing unit;

FIG. 15 is a view illustrating the configuration of an image processing apparatus which includes a GMV recording unit; and

FIG. 16 is a view illustrating an example of the hardware configuration of the image processing apparatus according to the embodiment of the present disclosure.

### DETAILED DESCRIPTION OF EMBODIMENTS

Hereinafter, an image processing apparatus, an image processing method, and a program according to embodiments of the present disclosure will be described with reference to the drawings. Meanwhile, the description will be performed in the order of following items:

1. Embodiment of superimposition processes performed on RAW image and full-color image using the same circuit

(1-1) Process performed on RAW image when image is photographed

(1-2) Process performed on full-color image when reproduction is performed

2. Example of hardware configuration used for superimposition process

(2-1) Example of process performed on input image (RAW image) from solid-state imaging device

(2-2) Example of process performed on input image (YUV image) from record reproduction unit

3. Other embodiments

(3-1) Embodiment in which high resolution processing unit is established

(3-2) Embodiment in which GMV, calculated when superimposition process is performed on RAW image, is used for superimposition process performed on full-color image

4. Example of hardware configuration of image processing apparatus

5. Arrangement of configuration of present disclosure

### 1. Embodiment of Superimposition Processes Performed on RAW Image and Full-Color Image Using the Same Circuit

First, as a first embodiment of an image processing apparatus according to the present disclosure, an embodiment in which a superimposition processes is performed on a RAW image and a full-color image using the same circuit will be described.

Meanwhile, the image processing apparatus according to the present disclosure is realized using, for example, an imaging apparatus, a Personal Computer (PC) or the like. Hereinafter, an example of a process, performed when an image process according to the present disclosure is performed using an imaging apparatus, will be described.

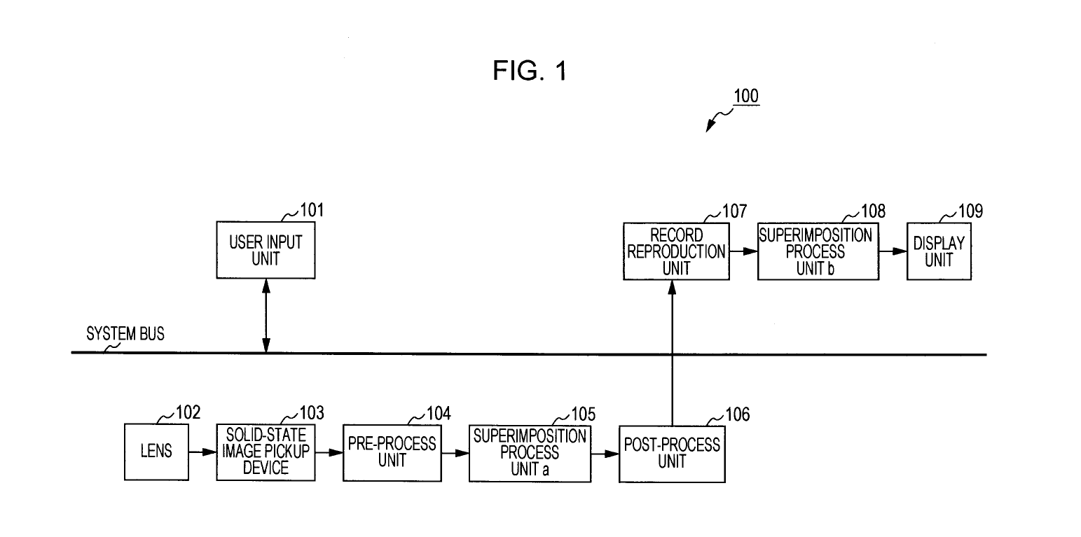

FIG. 1 is a view illustrating an example of the configuration of an imaging apparatus 100 which is an example of the image processing apparatus according to the present disclosure. The imaging apparatus 100 inputs a RAW image, that is, a mosaic image, which is photographed when an image is photographed, and then performs an image superimposition process in order to realize noise reduction and high resolution.

The superimposition processing unit a 105 of the imaging apparatus 100 in FIG. 1 performs the superimposition process on the RAW image.

Further, the imaging apparatus 100 which is an example of the image processing apparatus according to the present disclosure performs the image superimposition process on a full-color image which is generated based on the RAW image in order to realize noise reduction and high resolution.

The superimposition processing unit b 108 of the imaging apparatus 100 in FIG. 1 performs the superimposition process on the full-color image.

Meanwhile, although the superimposition processing unit a 105 and the superimposition processing unit b 108 are shown as separate blocks in FIG. 1, the superimposition processing unit a 105 and the superimposition processing unit b 108 are set as circuit configurations which use common hardware. The detailed circuit configurations will be described in latter part.

Hereinafter, first,

(1-1) Process performed on RAW image when image is photographed

(1-2) Process performed on full-color image when reproduction is performed will be sequentially described.

### (1-1) Process Performed on Raw Image when Image is Photographed

First, a process, in which N+1 RAW images are superimposed on in the case of imaging, using the imaging apparatus which is an example of the image processing apparatus according to the present disclosure will be described with reference to FIG. 1. N is an integer number which is equal to or greater than 1. Meanwhile, although the superimposition process performed on the RAW image can be performed on either a still image or a motion image, an example of a process performed on a still image will be described in the embodiment below.

FIG. 1 illustrates the configuration of the imaging apparatus 100 as an example of the configuration of the image processing apparatus according to the present disclosure. At a timing that imaging starts by operating the user input unit 101, such as a shutter, the solid-state imaging device 103 converts an optical image which is incident from a lens (optical system) 102 into a 2-Dimensional (2D) electrical signal (hereinafter, image data). Meanwhile, the solid-state imaging device 103 is, for example, a Charge Coupled Device (CCD) or a Complementary Metal Oxide Semiconductor (CMOS).

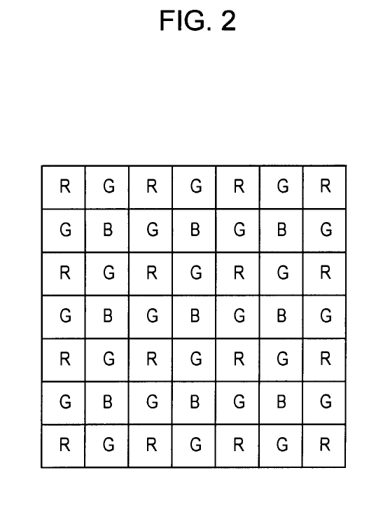

The output of a solid-state imaging device in a single plate manner is, for example, the RAW image of a Bayer arrangement shown in FIG. 2. That is, only any of RGB signals based on the configuration of a color filter is generated as each pixel signal. The RAW image is called, for example, a mosaic image, and a full-color image is generated by interpolating the entire set of RGB pixel values using the mosaic image for all pixels. Meanwhile, the pixel value interpolation process is called, for example, a demosaic process.

As described above, when the noise reduction process or the high resolution process is performed, effective noise reduction and high resolution are realized by using a larger number of images which include the same subject. For example, when N+1 images are used for an image process performed for, for example, the noise reduction and high resolution, a process of applying N+1 RAW images by continuously photographing the N+1 images so that N+1 RAW images are photographed, or a process of applying N+1 full-color images which are generated by applying the N+1 RAW images is performed.

A pre-processing unit 104 performs a process of correcting the defects of an image sensor, for example, the correction of vertical or horizontal stripes which are contained in the photographed image. An image output from the pre-processing unit 104 is input to the superimposition processing unit a 105, and the superimposition process is performed on N+1 images. A post-processing unit 106 performs a color interpolation process (demosaic process) of converting a RAW image into a full-color image, a linear matrix for increasing white balance and color reproductivity, and an edge emphasis process of improving visibility, or the like, and the resulting image is encoded using a compression codec, such as JPEG or the like, and then stored in a record reproduction unit (SD memory or the like) 107.

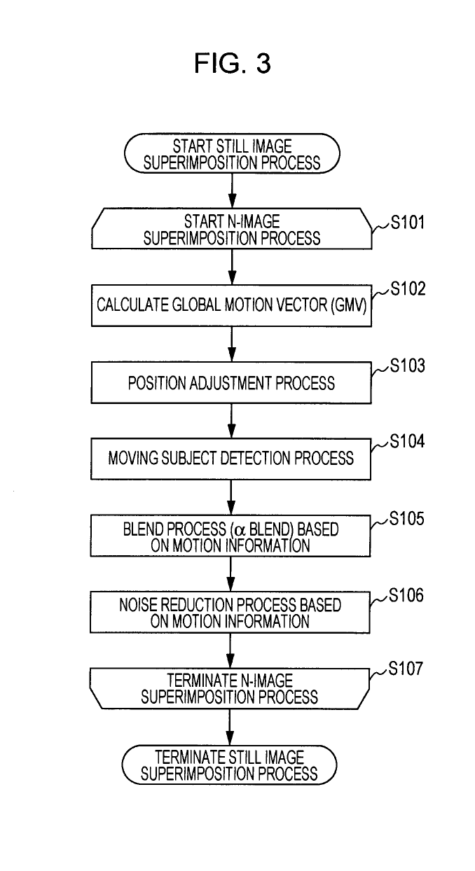

A process performed by the superimposition processing unit a 105 will be described with reference to a flowchart shown in FIG. 3.

In step S101, an N-image superimposition process starts.

Meanwhile, hereinafter, image data, which becomes the standard of position adjustment from among N+1 images which are continuously photographed by the imaging apparatus, is called a standard frame. The standard frame uses a single image frame which is picked up, for example, immediately after a shutter is pressed. N image frames obtained after the standard frame become reference frames.

A frame, used for the superimposition process, from among N+1 images is called a reference frame.

In step S102, a Global Motion Vector (GMV) calculation process is performed. The GMV calculation process is a process of receiving a standard frame and a reference frame as input and calculating a global (entire image) motion vector between the two frames. For example, a motion vector corresponding to the motion of a camera is obtained.

Next, in step S103, the position adjustment process is performed. This position adjustment process is a process of reading a standard frame and a single reference frame in which the Global Motion Vector (GMV) is obtained, and then adjusting the position of the reference frame to the standard frame using the GMV obtained by performing the GMV calculation process. An image, generated by performing this process, that is, the process of adjusting the position of the reference frame to the position of the standard frame based on the GMV, is called a motion-compensated image.

In step S104, a moving subject detection process is performed. This process is a process of obtaining the difference between the standard frame and an image (a motion-compensated image) corresponding to the reference frame, the position of which is adjusted to that of the standard frame, and then detecting a moving subject.

With respect to the standard frame and the reference frame, the position of which is adjusted to that of the standard frame, when all the subjects are stopped, the same parts of the same subject are photographed in the positions of pixels corresponding to the two images by the position adjustment in step S103, and the difference between the pixel values of the two images is approximately 0. However, for example, when a subject includes a moving subject such as a vehicle or a human, the pixel portions of the moving subject have motion which is different from the above-described GMV which is the motion vector of the whole image. Therefore, even when position adjustment is performed based on the GMV, the same parts of the same subject are not positioned in corresponding pixel positions which includes the moving subject included in the two images, so that the difference between pixel values of the two images becomes larger.

In step S104, the moving subject detection process is performed by obtaining the difference between the pixels corresponding to the standard frame and the reference frame, the position of which is adjusted to that of the standard frame, as described above. The results of the detection are output as motion detection information α in units of each pixel (0<=α<=1, where 0 indicates the determination of motion, and 1 indicates the determination of stillness (motion is not present)).

In step S105, a superimposed frame (a blended image) is generated by superimposing (blending) the standard frame on the reference frame image (motion-compensated image), obtained after position adjustment is performed based on the GMV, based on the motion detection information α in units of each pixel calculated in step S104.

When N reference images are superimposed with respect to a single initial standard image, the process of steps S102 to S106 is repeated N times. A blended image which is the superimposed frame generated in step S106 is used as a standard frame in a subsequent superimposition process.

The superimposition (blend) process, performed on the standard frame obtained in step S105 and the reference frame image (motion-compensated image) obtained after position adjustment is performed based on the GMV, will be described in detail.

The pixel values of the target pixels of a standard frame obtained when a N-th superimposition process (a frame on which superimposition process was performed (N−1) times) and a reference frame ((N+1)-th frame) are expressed as:

standard frame: mlt_{N-1}, and

reference frame: frm_{N+1}.

Meanwhile, the images have been imaged temporally afterward as the index, such as (N−1), (N+1), or the like, increases.

Further, the result of the moving subject detection of the target pixel is α.

Blend Equation (Equation 1), obtained when N-th superimposition process using the above-described data is performed, is expressed below.

When N is equal to or greater than 2,

$${mlt}_{N} = \frac{α}{N + 1} \times {frm}_{N + 1} + ( 1 - \frac{α}{N + 1} ) \times {mlt}_{N - 1} , 0 \leq α \leq 1 \\ When N is 1 , \\ {mlt}_{1} = \frac{α}{2} \times {frm}_{2} + ( 1 - \frac{α}{2} ) \times {frm}_{1} , 0 \leq α \leq 1 \qquad ( Equation 1 )$$

According to the above Equation (Equation 1), a superimposed frame (blended image) is generated by blending the pixel values of pixels corresponding to the standard image and the position-adjusted reference image (motion-compensated image).

In the blend process, when the superimposition process is performed N times while using N+1 still images as process targets as described above, the N-th superimposition process is performed based on the above Equation using:

(N−1)-th superimposition-processed image mlt_{N-1}, and

(N+1)-th superimposition-unprocessed image frm_{N+1}.

When the value of the motion detection information α in units of each pixel is large, that is, in the pixel positions estimated as a stationary subject, the blend ratio of the position-adjusted reference image (motion-compensated image) is set to a large value. When the value of the motion detection information α in units of each pixel is small, that is, in the pixel positions estimated as a moving subject, the blend ratio of the position-adjusted reference image (motion-compensated image) is set to a small value. As described above, the blend process is performed based on motion information in units of a pixel.

After the blend process is performed in step S105, a noise reduction process is further performed in step S106.

The process in step S106 is a pixel value updating process which is performed according to Equation below (Equation 2) when N is equal to or greater than 2, and which accompanies with pixel value smoothing.

An image corresponding to the pixel value mlt_{N} of the blended image, which was calculated in the blend process in the previous step S105 is updated according to the following Equation (Equation 2):

mlt_{N}=LPF(α)*mlt_{N} (Equation 2)

However, in the above Equation (Equation 2), * means a convolution operation of 2D data defined as (LPF (α)) and 2D image of mlt_{N}.

α is the motion detection information α in units of each pixel (0<=α<=1, where 0 indicates the determination of motion, and 1 indicates the determination of stillness (motion is not present)).

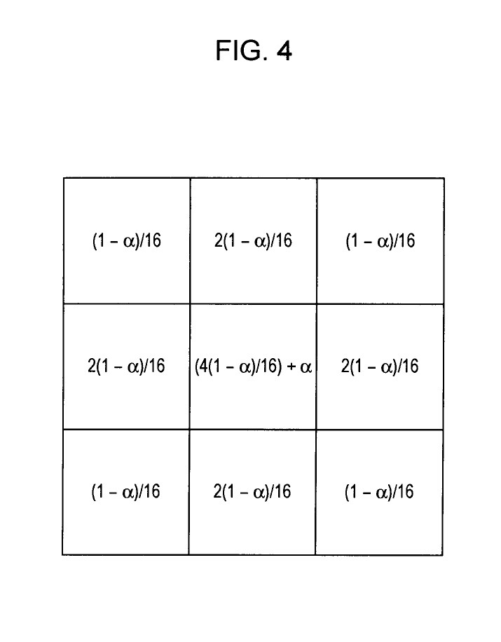

LPF (α) is the filter coefficient of a low-pass filter which allows only lower band components to be passed as a becomes a larger value, and which allows almost all frequency bands (that is, including high band components) to be passed when the value a is small. A detailed example of the value of the low-pass filter is a 3×3 2D data low-pass filter shown in FIG. 4.

The low-pass filter shown in FIG. 4 is a low-pass filter corresponding to 3×3 pixels. For example, the filter is configured in such a way that 3×3 pixels centering on an updated pixel are selected from the image region of an image to be processed, the selected pixels (3×3=9) are multiplied by respective 9 filter coefficients shown in FIG. 4, the results of the multiplications are added, and the result of the addition is used as an updated pixel value.

As shown in FIG. 4, the coefficients are set depending on the motion detection information α. That is, the LPF (α) is the filter coefficient of the low-pass filter, which allows low band components to be passed as the value α becomes larger, and which allows almost all frequency band (that is, including high band components) to be passed when the value α is small.

That is, when the value α is large, that is, in the pixel positions estimated as a stationary subject, the updated value, obtained after the LPF process is performed, has the high degree of the dependence of the pixel value of a central pixel, and the ratio of change to which the LPF is applied is low.

Meanwhile, when the value α is small, that is, in the pixel positions estimated as a moving subject, the degree of dependence of surrounding pixels is high, and the ratio of change to which the LPF is applied is displayed as being high. That is, the pixel value is smoothed out.

As a result, the noise reduction effect of a moving subject region becomes higher.

Meanwhile, in the case where N=1, mlt_{N} is not updated. When the value of the motion detection information α in units of each pixel is large, that is, in the pixel positions estimated as the stationary subject, the pass band of the low-pass filter corresponds to the entire frequency band, so that the image is not updated in actual, thereby remaining as a clear image. Meanwhile, when the value of the motion detection information α in units of each pixel is small, that is, in the pixel positions estimated as the moving subject, the pass band of the low-pass filter is limited to low frequency components, so that a process of smoothing out the image is performed.

In the blend process in step S105, although noise reduction effect obtained by superimposition appears as sufficient effects in a stationary subject region, the noise reduction effect obtained by superimposition is low in a moving subject region.

However, when the process in step S106 is performed, noise reduction is performed by LPF on the portion where the superimposition is not performed, for example, on the moving subject region, in the blend process, so that noise reduction is performed on entire pixels regardless of value α as a result.

That is, the noise reduction effect, obtained by superimposing images in step S105, is shown in the stationary subject region. Meanwhile, the noise reduction effect, obtained by applying the low-pass filter or the like in step S106, is shown in the moving subject region.

As a result, noise reduction effect is shown in any of the stationary subject region and the moving subject region.

### (1-2) Process Performed on Full-Color Image when Reproduction is Performed

Continuously, an example of a process performed on a full-color image will be described. This process is performed when, for example, an image is displayed on the display unit 109 of the imaging apparatus 100 shown in FIG. 1. Meanwhile, although the superimposition process performed on the full-color image can be performed on any of a still image and a motion image, an example of a process performed on a motion image will be described in an embodiment below.

In the post-processing unit 106 of the imaging apparatus 100 shown in FIG. 1, a color interpolation process (demosaic process) for converting a RAW image into a full-color image, a linear matrix for increasing white balance and color reproductivity, and an edge enhancement process for improving visibility, or the like is performed, encoding is performed using a compression codec (motion image codec H.264, Moving Picture Experts Group (MPEG)-2, or the like), such as Joint Photographic Experts Group (JPEG) or the like, and then the resulting image is stored in the record reproduction unit (SD memory or the like) 107.

In the display unit 109, for example, a list of thumbnail images corresponding to the full-color image which is completely stored in the record reproduction unit (SD memory or the like) 107 is displayed. If a user inputs an instruction to select and reproduce a specific thumbnail image, the record reproduction unit 107 decodes an image corresponding to the selected thumbnail. The decoded image becomes image data which has, for example, a full-color image format, such as Red, Green, and Blue (RGB) or the like, or a YUV image format related to brightness and chrominance. The decoded image is input to the superimposition processing unit b 108.

In the superimposition processing unit b 108, the decoded image, such as the full-color image or the like, is input and the image superimposition process is performed for noise reduction and high resolution. The results of the superimposition process are transmitted to the display unit 109 and then displayed thereon.

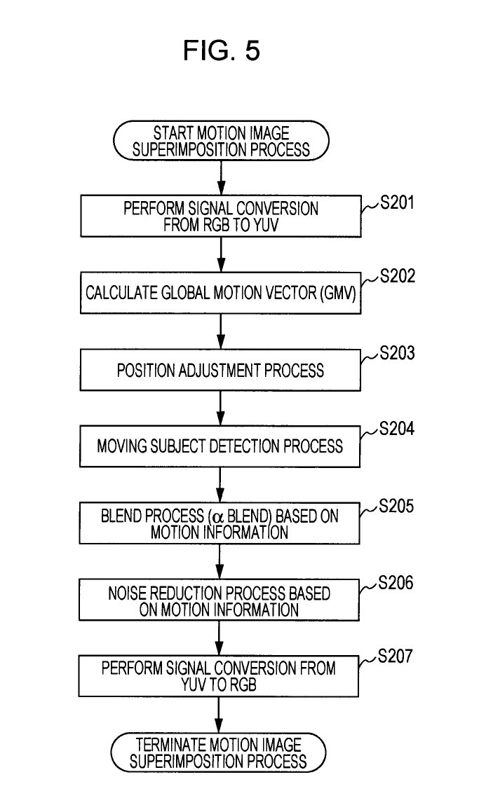

The flow of the process performed by the superimposition processing unit b 108 will be described with reference to a flowchart shown in FIG. 5. Meanwhile, the example of the process which will be described below will be described as an example of the reproduction process of a motion image. The reproduction of the motion image is performed by continuously displaying still images which are photographed at a predetermined time interval. When superimposition is performed during the reproduction of the motion image process, for example, the newest frame input from the record reproduction unit 107 is used as a standard frame, and a frame before the standard frame is used as a reference frame.

When an image input from the record reproduction unit 107 is input in a full-color format (RGB), an RGB→YUV conversion process is performed in step S201, so that the image is converted into brightness and chrominance signals. Meanwhile, when the image is input in a YUV format, the RGB→YUV conversion process in step S201 is omitted.

In step S202, the GMV calculation process is performed. This GMV calculation process is a process of inputting the standard frame and the reference frame, and calculating the global motion vector (entire image) between the two frames. For example, a motion vector corresponding to the motion of a camera is obtained.

In subsequent step S203, a position adjustment process is performed. This position adjustment process is a process of reading the standard frame and the single reference frame in which the GMV is obtained, and adjusting the position of the reference frame into the position of the standard frame using the GMV obtained in the GMV calculation process. An image, which is generated by performing this process, that is, the process of adjusting the position of the reference frame into the position of the standard frame, is called a motion-compensated image based on the GMV.

In step S204, a moving subject detection process is performed. This process is a process of detecting a moving subject by obtaining the difference between the standard frame and the reference frame image (motion-compensated image), the position of which is adjusted to that of the standard frame. The results of the detection are output as a value of the motion detection information α in units of each pixel (where 0<=α<=1, 0 indicates the determination of motion, and 1 indicates the determination of stillness (motion is not present).

In step S205, the standard frame is blended with the reference frame image (motion-compensated image), obtained after the position adjustment is performed based on the GMV, based on the motion detection information α in units of each pixel calculated in step S204, thereby generating a superimposed frame (blended image).

In the α blend process (superimposition process) performed in step S205, the standard frame ((N+1)-th frame frm_{N+1}) is blended with the reference frame ((N−1)-th superimposed frame mlt_{N-1}) based on the value α obtained from the moving subject detection unit. In the α blend process (superimposition process), the superimposition process is performed only on a brightness signal Y in the YUV format. An Equation (Equation 3) for an N-th superimposition process is expressed below.

When N is equal to or greater than 2,

$${mlt}_{N} = \frac{α}{2} \times {mlt}_{N - 1} + ( 1 - \frac{α}{2} ) \times {frm}_{N + 1} , 0 \leq α \leq 1 \\ When N is 1 , \\ {mlt}_{1} = \frac{α}{2} \times {frm}_{1} + ( 1 - \frac{α}{2} ) \times {frm}_{2} , 0 \leq α \leq 1 \qquad ( Equation 3 )$$

According to the above Equation (Equation 3), a superimposed frame (blended image) is generated by blending the pixel values of pixels corresponding to the standard image and the position-adjusted reference image (motion-compensated image).

In the blend process, when the superimposition process is performed N times while using N+1 motion images as process targets as described above, the N-th superimposition process is performed based on the above Equation using:

(N−1)-th superimposition-processed image mlt_{N-1}, and

(N+1)-th superimposition-unprocessed image frm_{N+1}.

When the value of the motion detection information α in units of each pixel is large, that is, in the pixel positions estimated as a stationary subject, the blend ratio of the position-adjusted reference image (motion-compensated image) is set to a large value. When the value of the motion detection information α in units of each pixel is small, that is, in the pixel positions estimated as a moving subject, the blend ratio of the position-adjusted reference image (motion-compensated image) is set to a small value. As described above, the blend process is performed based on motion information in units of a pixel.

After the blend process is performed in step S205, a noise reduction process is further performed in step S206.

The process in step S206 is a pixel value updating process which is performed according to Equation below (Equation 4) when N is equal to or greater than 2, and which accompanies with pixel value smoothing.

An image corresponding to the pixel value mlt_{N} of the blended image, which was calculated in the blend process in previous step S205 is updated according to the following Equation (Equation 4):

mlt_{N}=LPF(α)*mlt_{N} (Equation 4)

However, in the above Equation (Equation 4), * means a convolution operation of 2D data defined as LPF (a) and 2D data of mlt_{N}.

α is the motion detection information α in units of each pixel (0<=α<=1, where 0 indicates the determination of motion, and 1 indicates the determination of stillness (motion is not present)).

Meanwhile, the Equation (Equation 4) is the same Equation as the Equation (Equation 2) which was described above in the process of step S106 of the flow in FIG. 3.

LPF (α) is the filter coefficient of a low-pass filter which allows only lower band components to be passed as α becomes a larger value, and which allows almost all frequency bands (that is, including high band components) to be passed when the value α is small. A detailed example of the value of the low-pass filter is a 3×3 2D data shown in FIG. 4.

Meanwhile, in the case where N=1, mlt_{N} is not updated. When the value of the motion detection information α in units of each pixel is large, that is, in the pixel positions estimated as the stationary subject, the pass band of the low-pass filter corresponds to the entire frequency band, so that the image is not really updated, thereby remaining as a clear image. Meanwhile, when the value of the motion detection information α in units of each pixel is small, that is, in the pixel positions estimated as the moving subject, the pass band of the low-pass filter is limited to low frequency components, so that a process of smoothing out the image is performed.

In the blend process in step S205, although noise reduction effect obtained by superimposition appears as sufficient effects in a stationary subject region, the noise reduction effect obtained by superimposition is low in a moving subject region.

However, when the process in step S206 is performed, noise reduction is performed by LPF on the portion where the superimposition is not performed, for example, on the moving subject region, in the blend process, so that noise reduction is performed on entire pixels regardless of the value α as a result.

That is, the noise reduction effect, obtained by superimposing images in step S205, is shown in the stationary subject region. Meanwhile, the noise reduction effect, obtained by smoothing the pixel value in such a way as to apply the low-pass filter or the like in step S206, is shown in the moving subject region.

As a result, noise reduction effect is shown in any of the stationary subject region and the moving subject region.

The superimposed frame generated by the process of step S206 becomes the reference frame of a subsequent superimposition process. A new superimposition process is performed using the newest frame which corresponds to a subsequent frame as the standard frame.

At the end, in step S207, a YUV→RGB conversion process is performed on a brightness signal Y, on which the superimposition process is performed, and a chrominance signal UV, which is output from an RGB→YUV conversion unit, such that the formats thereof are converted into full-color formats, and the full-color image is displayed on the display unit 109.

Although the example of the above-described process includes: (1-1) Process performed on RAW image when image is photographed, and (1-2) Process performed on full-color image when reproduction is performed, for example, the RGB→YUV conversion is performed and the superimposition process is performed on only the brightness signal Y in the YUV format with respect to the process performed on the full-color image when reproduction is performed.

When the above-described process is performed, a signal in units of each pixel, which is used to perform the superimposition process becomes: (1-1) a signal (for example, the signal of any one of RGB) which is set to a pixel configuring the RAW image in the case of the process performed on the RAW image obtained when the image is photographed, or (1-2) only the brightness signal Y in the YUV format of each of the pixels which configure the full-color image in the case of the process performed on the full-color image obtained when the image is reproduced.

That is, a process can be performed on each of the pixels configuring an image using a single signal value in any of the cases of the superimposition process which is performed on the RAW image and the superimposition process which is performed on the full-color image.

As a result, the superimposition processing unit a 105 which performs the superimposition process on the RAW image and the superimposition processing unit b 108 which performs the superimposition process on the full-color image can use the same circuit for performing the superimposition process by only determining whether to use each pixel value of the RAW image or each pixel brightness value Y of the full-color image as an input signal.

With this configuration, a process using a single superimposition process circuit can be realized with respect to two different pieces of image data, that is, the RAW image and the full-color image.

Further, according to the present embodiment, with respect to a pixel in which noise reduction effect obtained based on the superimposition effect is not expected when a moving subject is projected, noise reduction is performed using a spatial LPF, so that an image in which noise is not present can be output with respect to all the pixels regardless whether a moving subject is present or not.

Meanwhile, in Japanese Unexamined Patent Application Publication No. 2009-194700 which was described above as the related art, the number of superimposition is counted, and, at the end, the strength of the noise reduction is varied depending on the number. In this related art, the effect of strong noise reduction should be excluded on the portions where the number of superimposition is small. It is necessary to increase the number of the taps of the LPF filter (the size of the filter) for the strong noise reduction, thereby causing an increase in circuit size or operation amount.

Meanwhile, according to the present disclosure, it is preferable that the number of the taps of the LPF filter of the noise reduction processing unit 207 be small. The reason for this is that, if the number of superimposition is small, the process of the noise reduction processing unit 207 is performed whenever an image is input. In other words, a filter which has a small number of taps is processed a plurality of times, with the result that a filter which has a large number of taps is processed. As described above, in the configuration of the present disclosure, the circuit size and the operation amount are small.

Meanwhile, a process target image may be any of a motion image and a still image. Although examples of the processes performed on the RAW image of a still image and the full-color image of a motion image were described in the above-described embodiment, the superimposition process using a single common circuit can be performed on the RAW image of a motion image and the full-color image of a still image. The detailed circuit configuration will be described using the following items.

### 2. Example of Hardware Configuration Used for Superimposition Process

Next, an example of hardware configuration used for the superimposition process will be described.

The following two examples of processes: (2-1) Example of process performed on input image (RAW image) from solid-state imaging device, and (2-2) Example of process performed on input image (full-color image (YUV image)) from record reproduction unit will be sequentially described.

Meanwhile, in the following description of hardware, the process performed on a RAW image and a process performed on a full-color image are realized using a single common circuit configuration, and a memory capacity reduction process which is another characteristic of the configuration of the present disclosure and which is necessary for the superimposition process will be described.

### (2-1) Example of Process Performed on Input Image (RAW Image) from Solid-State Imaging Device

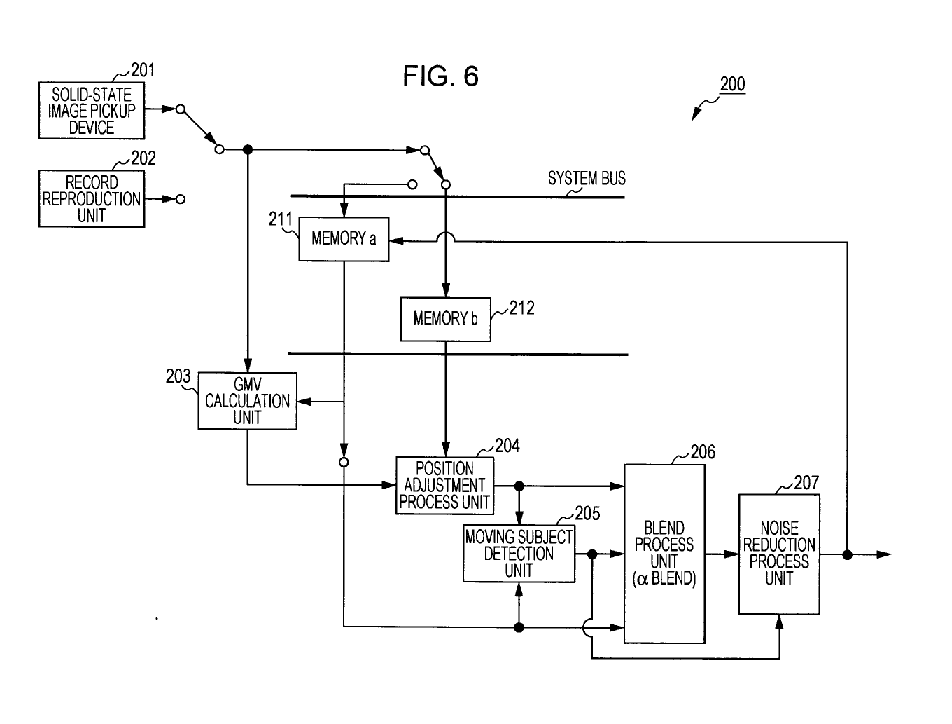

First, a process example of an image superimposition (blend) process which is performed on an input image (RAW image) from the solid-state imaging device will be described with reference to FIGS. 6 to 10.

FIG. 6 is a view illustrating a common detailed circuit configuration used as the superimposition processing unit a 105 and the superimposition processing unit b 108 shown in FIG. 1.

A GMV calculation unit 203 shown in FIG. 6 executes the process in step S102 of the flow shown in FIG. 3 and the process in step S202 of the flow shown in FIG. 5.

A position adjustment processing unit 204 shown in FIG. 6 executes the process in step S103 of the flow shown in FIG. 3 and the process in step S203 of the flow shown in FIG. 5.

A moving subject detection unit 205 shown in FIG. 6 executes the process in step S104 of the flow shown in FIG. 3 and the process in step S204 of the flow shown in FIG. 5.

A blend processing unit 206 shown in FIG. 6 executes the process in step S105 of the flow shown in FIG. 3 and the process in step S205 of the flow shown in FIG. 5.

A noise reduction processing unit 207 shown in FIG. 6 executes the process in step S106 of the flow shown in FIG. 3 and the process in step S206 of the flow shown in FIG. 5.

When a superimposition processing unit 200 shown in FIG. 6 functions as the superimposition processing unit a 105 shown in FIG. 1, a RAW image is input from a solid-state imaging device 201 (which is the same as the solid-state imaging device 103 in FIG. 1) and the superimposition process is performed on the RAW image.

Meanwhile, when the superimposition processing unit 200 functions as the superimposition processing unit b 108 shown in FIG. 1, the brightness signal Y of an YUV image is input from a record reproduction unit 202 (which is the same as the record reproduction unit 107 in FIG. 1) and the superimposition process is performed on the full-color image.

The respective frame memory a 211 and the memory b 212 in FIG. 6 are memories which store the RAW image output from the solid-state imaging device 201 (which is the same as the solid-state imaging device 103 in FIG. 1) and the full-color image output from the record reproduction unit 202 (which is the same as the record reproduction unit 107 in FIG. 1), respectively.

Hereinafter, first, a process example when the superimposition processing unit a 105 shown in FIG. 1 performs the process, that is, the process which was described with reference to the flowchart shown in FIG. 3, will be described.

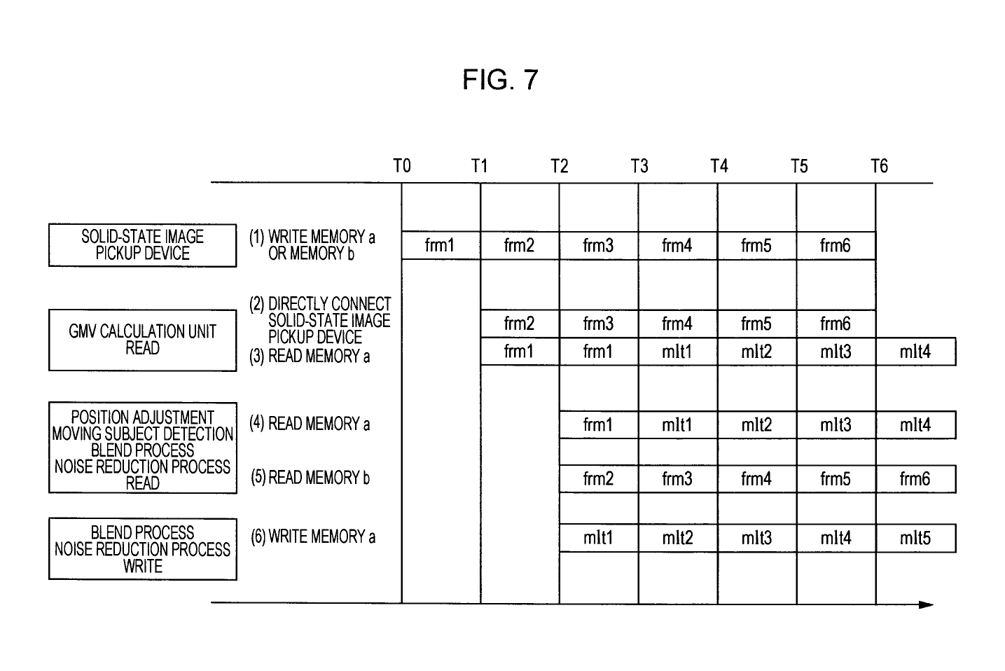

FIG. 7 is a timing chart illustrating a process performed when the superimposition processing unit shown in FIG. 6 performs the superimposition process on the RAW image.

FIG. 7 illustrates the passage of time T0, T1, T2 . . . from left to right.

Further, FIG. 7 illustrates, from above, each of the following processes (1) to (6): (1) a process of writing RAW image into the memory a 211 and the memory b 212 from the solid-state imaging device 201, (2) a process of inputting image to the GMV calculation unit 203 from the solid-state imaging device 201, (3) a process of reading an image from the memory a 211 using the GMV calculation unit 203, (4) a process of reading an image from the memory a 211 using the position adjustment processing unit 204, the moving subject detection unit 205, the blend processing unit 206, and the noise reduction processing unit 207, (5) a process of reading an image from the memory b 212 using the position adjustment processing unit 204, the moving subject detection unit 205, the blend processing unit 206, and the noise reduction processing unit 207, and (6) a process of writing an image into the memory a 211 using the blend processing unit 206 and the noise reduction processing unit 207.

Meanwhile, an image signal which is written into the memory a 211 and the memory b 212 corresponds to the RAW image or the superimposition image which is generated based on the RAW image, and has a single pixel value of any of RGB with respect to a single pixel. That is, only a single signal value is stored with respect to a single pixel.

Reference symbols frm1, frm2, frm3 . . . shown in FIG. 7 indicate image frames (RAW images) which are used in the superimposition process and obtained before the superimposition process is performed, and reference symbols mlt1, mlt2, mlt3, . . . indicate image frames on which the superimposition process is performed.

An initial superimposed frame which is generated using the image frame (frm1) and the image frame (frm2) is the image frame (mlt1).

This corresponds to the process of generating the initial superimposition image frame (mlt1) shown in the process (6) using the image frame (frm1) and the image frame (frm2) of the processes (4) and (5) of T1 to T2 of the timing chart shown in FIG. 7.

Next, at a subsequent timing T2 to T3, a second superimposition image frame (mlt2) shown in the process (6) is generated using the initial superimposition image frame (mlt1) and the image frame (frm3) shown in the processes (4) and (5) of the timing chart T2 to T3 shown in FIG. 7.

As described above, with the passage of time, a new superimposition image frame (mltn+1) is sequentially generated and then updated using the superimposition image frame (mltn), which is generated immediately before, and the newest input image (frmn+2). For example, when N superimpositions are performed using N+1 images, a superimposition image frame (mltN), which is generated after the superimposition process is performed N times, is generated, and then the process in the unit is terminated.

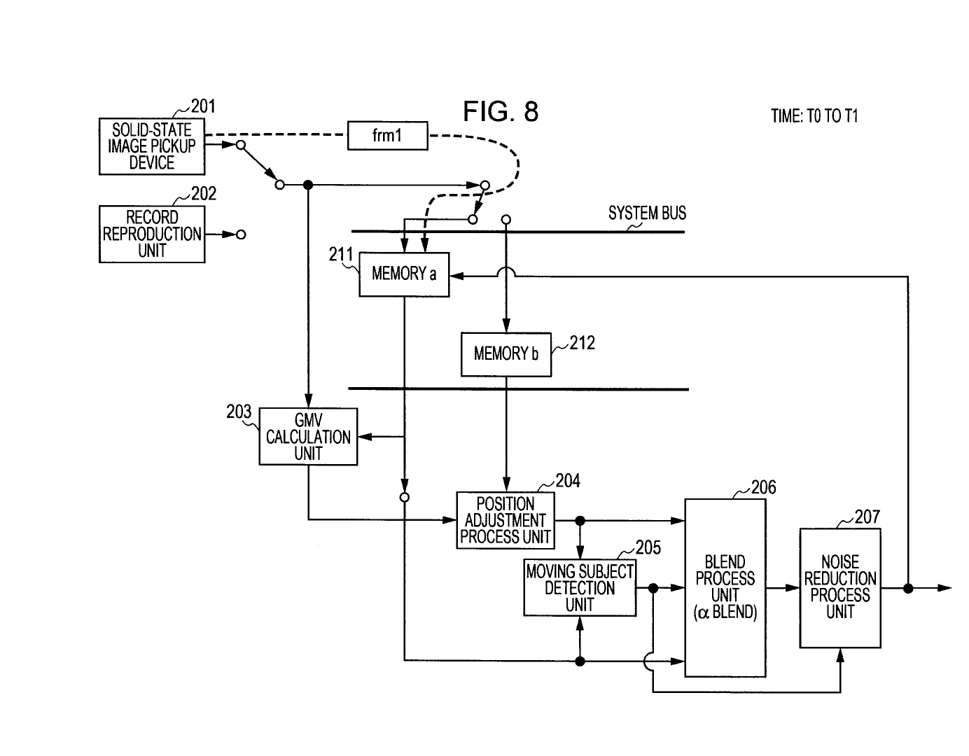

Hereinafter, the process sequence of the superimposition process performed on the RAW image by the superimposition processing unit 200 (which is the same as the superimposition processing unit a 105 and the superimposition processing unit b 108 in FIG. 1) shown in FIG. 6 will be described with reference to the timing chart in FIG. 7 and the state diagrams at the respective timings of FIGS. 8 to 10.

At the timing T0 to T1 (refer to FIG. 7) that image pick-up starts when a shutter is pressed, the image data (frm1) which is output from the solid-state imaging device 201 shown in FIG. 6 is written in the frame memory a 211.

FIG. 8 shows the state of the timing T0 to T1.

Continuously, at the timing T1, the second image data (frm2) is transmitted from the solid-state imaging device 201, and is input to the GMV calculation unit 203 at the same time that the second image data (frm2) is written in the frame memory b 212. At the same time, the first image data (frm1) is input to the GMV calculation unit 203 from the frame memory a 211, so that the GMV calculation unit 203 obtains the GMV between the two frames, that is, the first image data (frm1) and the second image data (frm2).

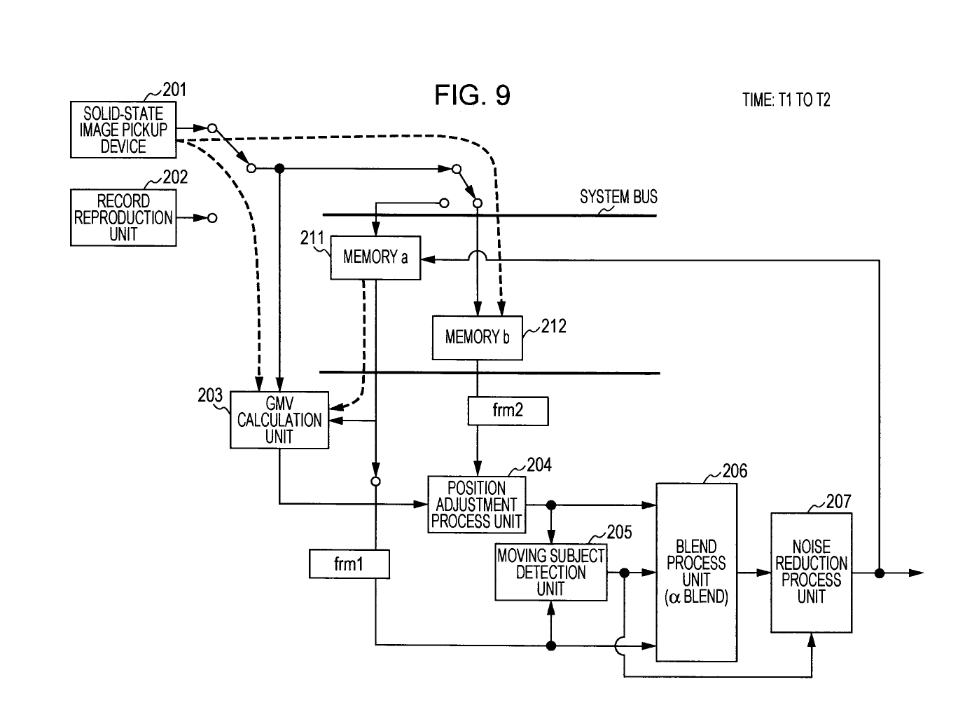

FIG. 9 shows the state of the timing T1 to T2.

At the timing T2, the second image data (frm2) is input to the position adjustment unit 204 from the frame memory b 212.

Further, the GMV calculated by the GMV calculation unit 203, that is, the GMV between the first image data (frm1) and the second image data (frm2) obtained at the timing T1 to T2 is input, and then the position adjustment process of adjusting the position of the second image data (frm2) into the subject position of the first image data (frm1) is performed based on the input GMV. That is, the motion-compensated image is generated.

Meanwhile, the present process example is an example of the superimposition process performed on a still image. In the case of the still image, position adjustment is performed in such a way that a previous image is used as a standard image, a succeeding image is used as a reference image, and the position of the succeeding reference image is adjusted to the position of the previous standard image.

The second image data (frm2), on which the position adjustment is performed, is input to the moving subject detection unit 205 and the blend processing unit 206, together with the first image data (frm1).

The moving subject detection unit 205 compares the pixel values corresponding to the positions of the first image data (frm1) and the second image data (frm2), on which the position adjustment is performed, generates motion detection information α (where 0<=α<=1, 0 indicates the determination of motion, and 1 indicates the determination of stillness (motion is not present) in units of a pixel based on the difference obtained through the comparison, and then outputs the motion detection information to the blend processing unit 206.

The blend processing unit 206 performs the blend process on the first image data (frm1) and the second image data (frm2), on which the position adjustment is performed, using the motion detection information α in units of each pixel (where 0<=α<=1), which is obtained by the moving subject detection unit 205, thereby generating a superimposed frame.

According to the above-explained Equation (Equation 1), the superimposed frame (blended image) is generated by blending the pixel values of the pixels corresponding to the standard image and the position-adjusted reference image (motion-compensated image).

The superimposed frame (mlt1), which is the first blended image generated by the blend process performed on the first image data (frm1) and the second image data (frm2), on which the position adjustment is performed, is generated.

Further, the noise reduction process is performed by the noise reduction processing unit 207. That is, after the blend process is performed, the noise reduction process in step S106 which was described in advance in the flow in FIG. 3 is performed.

When N is equal to or greater than 2, the pixel value updating process is performed based on the above-explained Equation (Equation 2). That is, a noise proposal process is performed, using, for example, a low-pass filter which has coefficients shown in FIG. 4. In the process using the LPF, when the value of the motion detection information α in units of each pixel is small, the pass band of the low-pass filter is limited to only low frequency components in the pixel positions estimated as, that is, a moving subject, thereby realizing effect of smoothing an image.

The image to be processed by the noise reduction processing unit 207 is overwritten in the frame memory a 211.

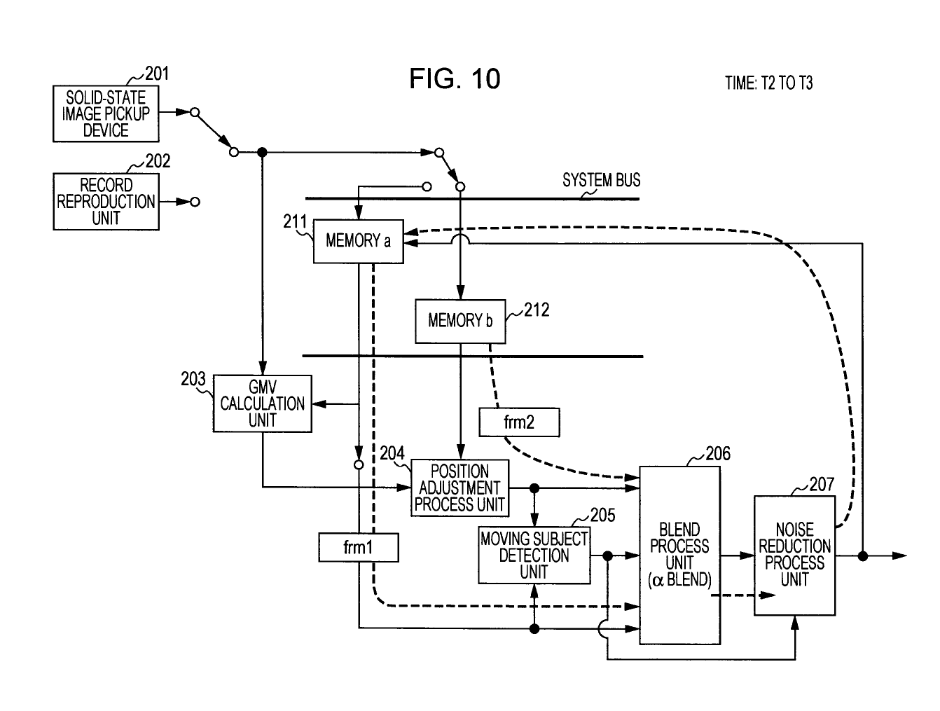

FIG. 10 is a view illustrating the state of the timing T2 to T3.

As understood based on the process described with reference to FIGS. 6 to 10, two memories which store two images, that is, the memory a 211 and the memory b 212 are used in the superimposition process using the superimposition processing unit 200 shown in FIG. 6, thereby realizing the superimposition process performed on an arbitrary number of images, for example, N images.

As described above, in the present embodiment, the largest number of images to be stored in the frame memories is two, which corresponds to the frame memories “a” and “b” regardless of the number of images on which the superimposition is performed. In the present embodiment, effect, which is the same as that of the case where all the N+1 images are stored in the frame memories, can be obtained while the capacities of the frame memories are saved.

### (2-2) Example of Process Performed on Input Image (YUV Image) from Record Reproduction Unit

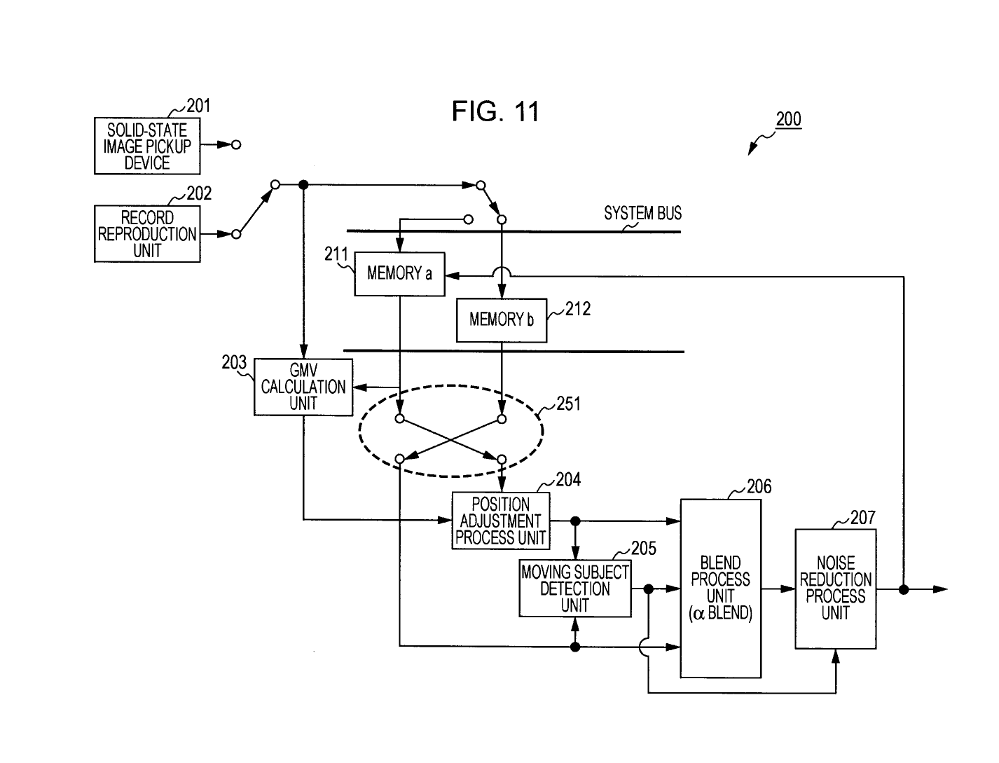

Continuously, a process example, performed on the input image (full-color image (YUV image)) by the record reproduction unit, will be described with reference to FIGS. 11 to 13.

FIG. 11 illustrates a circuit which is almost the same as the circuit which was described with reference to FIG. 6 in advance, and illustrates a common circuit configuration used as the superimposition processing unit a 105 and the superimposition processing unit b 108 shown in FIG. 1. However, when the circuit is used as the superimposition processing unit b 108, the connection configuration of a wire connection unit 251 is changed, and, further, an input configuration is changed such that input is performed from the record reproduction unit 202. This is realized by turning on or off switches which are established on the connection units of the wire connection unit 251 and the record reproduction unit 202.

Hereinafter, a process example, performed when the process performed by the superimposition processing unit b 108 shown in FIG. 1, that is, an example of a process which is performed when the process described with reference to the flowchart shown in FIG. 5 is performed will be described.

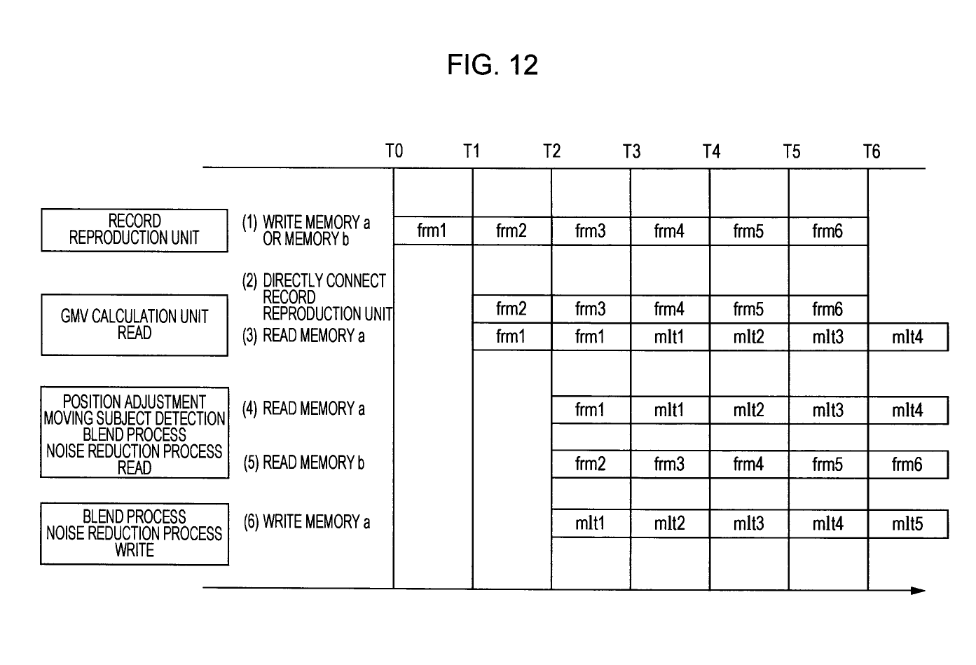

FIG. 12 is a timing chart illustrating a process performed when the superimposition processing unit shown in FIG. 11 performs the superimposition process using the brightness signal Y of a YUV image generated based on the full-color image.

FIG. 12 is a timing chart which is the same as FIG. 7, and illustrates the passage of time T0, T1, T2 . . . from left to right.

Further, from above, each of the following processes (1) to (6) is shown: (1) a process of writing the brightness signal Y of a YUV image into the memory a 211 and the memory b 212 from the record reproduction unit 202, (2) a process of inputting the brightness signal Y of the YUV image from the record reproduction unit 202 corresponding to the GMV calculation unit 203, (3) a process of reading an image signal (brightness signal Y) from the memory a 211 using GMV calculation unit 203, (4) a process of reading the image signal (brightness signal Y) from the memory a 211 using the position adjustment processing unit 204, the moving subject detection unit 205, the blend processing unit 206, and the noise reduction processing unit 207, (5) a process of reading the image signal (brightness signal Y) from the memory b 212 using the position adjustment processing unit 204, the moving subject detection unit 205, the blend processing unit 206, and the noise reduction processing unit 207, and (6) a process of writing the image signal (brightness signal Y) into the memory a 211 using the blend processing unit 206 and the noise reduction processing unit 207.

Meanwhile, an image signal which is written into the memory a 211 and the memory b 212 corresponds to the brightness signal Y image of an YUV image or the superimposition image which is generated based on the brightness signal Y image of the YUV image, and has a single pixel value of brightness signal Y1 with respect to a single pixel. That is, only a single signal value is stored with respect to a single pixel.

Reference symbols frm1, frm2, frm3 . . . shown in FIG. 12 indicate image frames which are used in the superimposition process and obtained before the superimposition process is performed, and reference symbols mlt1, mlt2, mlt3, . . . indicate image frames on which the superimposition process is performed.

An initial superimposed frame which is generated using the image frame (frm1) and the image frame (frm2) is the image frame (mlt1).

This corresponds to the process of generating the initial superimposition image frame (mlt1) shown in the process (6) using the image frame (frm1) and the image frame (frm2) of the processes (4) and (5) of T1 to T2 of the timing chart shown in FIG. 12.

Next, at a subsequent timing T2 to T3, a second superimposition image frame (mlt2) shown in the process (6) is generated using the initial superimposition image frame (mlt1) and the image frame (frm3) shown in the processes (4) and (5) of the timing chart T2 to T3 shown in FIG. 12.

As described above, with the passage of time, a new superimposition image frame (mltn+1) is sequentially generated and then updated using the superimposition image frame (mltn), which is generated immediately before, and the newest input image (frmn+2). For example, when N superimpositions are performed using N+1 images, a superimposition image frame (mltN), which is generated after the superimposition process is performed N times, is generated, and then the process in the unit is terminated.

Hereinafter, the process sequence of the superimposition process performed on the YUV image by the superimposition processing unit 200 (which is the same as the superimposition processing unit b 108 and the superimposition processing unit a 105 in FIG. 1) shown in FIG. 11 will be described with reference to the timing chart in FIG. 12.

Description will be focused on portions which are different from the process performed on the RAW image described with reference to FIGS. 6 to 10.

In this process, input to the superimposition processing unit 200 is performed not from the solid-state imaging device 201 but from the record reproduction unit 202, as shown in FIGS. 11 and 12.

For example, a reproduction target image selected by a user is selected and obtained from a memory by the record reproduction unit 107, and then output to the superimposition processing unit 200. Meanwhile, a brightness signal Y is generated when format conversion is performed such that an RGB format is converted into a YUV format as necessary, and then supplied to the memory a 211 and the memory b 212, so that the record reproduction unit 107 starts the process.

At a timing T0 to T1 (refer to FIG. 12), the image data (frm1) output from the record reproduction unit 202 shown in FIG. 11 is written into the frame memory a 211. Meanwhile, in the present example, the brightness signal Y is written into the frame memory a 211 and the frame memory b 212.

The state of the timing T0 to T1 is different from that of above-described FIG. 8 in that the data is output from the record reproduction unit 202.

Subsequently, at the timing T1, the second image data (frm2) is output from the record reproduction unit 202, and input to the GMV calculation unit 203 at the same time that the second image data (frm2) is written into the frame memory b 212 at this time. At the same time, the first image data (frm1) is input to the GMV calculation unit 203 from the frame memory a 211, so that the GMV between the two frames, that is, the first image data (frm1) and the second image data (frm2) is obtained by the GMV calculation unit 203.

The state of the timing T1 to T2 is different from that of above-described FIG. 9 in that the data is output from the record reproduction unit 202.

At the timing T2, the first image data (frm1) is input to the position adjustment unit 204 from the frame memory a 211, and the GMV between the first image data (frm1) and the second image data (frm2), which was obtained at the timing T1 to T2, is input, so that the position adjustment process of adjusting the first image data (frm1) into the subject position of the second image data (frm2) is performed based on the input GMV. That is, a motion-compensated image is generated.

Meanwhile, the present process example corresponds to a superimposition process example relevant to a motion image. In the case of a motion image, the position adjustment is performed in such a way that a succeeding image is used as a standard image, a preceding image is used as a reference image, and the preceding reference image is adjusted into the position of the succeeding standard image.

The first image data (frm1) on which the position adjustment is performed is input to the moving subject detection unit 205 and the blend processing unit 206, together with the second image data (frm2).

The moving subject detection unit 205 compares the pixel values of the positions corresponding to the position-adjusted first image data (frm1) and the second image data (frm2), generates motion detection information α (where 0<=α<=1, 0 indicates the determination of motion, and 1 indicates the determination of stillness (motion is not present) in units of a pixel based on the difference obtained through the comparison, and then outputs the motion detection information to the blend processing unit 206.

The blend processing unit 206 performs a blend process on the position-adjusted first image data (frm1) and the second image data (frm2) using the motion detection information α (where 0<=α<=1) in units of a pixel which is obtained by the moving subject detection unit 205, thereby generating a superimposed frame.

According to the above-explained Equation (Equation 3), the superimposed frame (blended image) is generated by blending the pixel values of pixels corresponding to the standard image and the position-adjusted reference image (motion-compensated image).

A superimposed frame (mlt1), which is the first blended image generated by performing the blend process on the position-adjusted first image data (frm1) and the second image data (frm2), is generated.

Further, the noise reduction process is performed by the noise reduction processing unit 207. That is, after the blend process is performed, the noise reduction process in step S106 which was described above in the flow in FIG. 3 is performed.

When N is equal to or greater than 2, the pixel value updating process is performed based on the above-explained Equation (Equation 4). That is, a noise reduction process is performed, using, for example, a low-pass filter which has coefficients shown in FIG. 4. In the process to which the LPF is applied, when the value of the motion detection information α in units of each pixel is small, the pass band of the low-pass filter is limited only to low frequency components in the pixel positions estimated, in other words, as a moving subject, thereby realizing the effect of smoothing the image.

The image to be processed by the noise reduction processing unit 207 is overwritten in the frame memory a 211, and then output to the display unit 109.

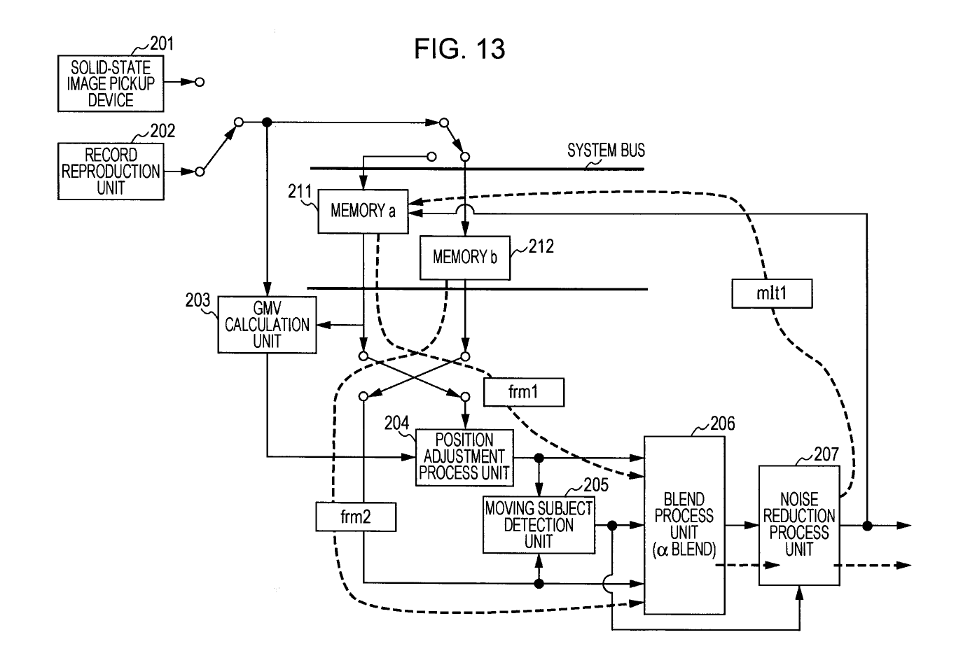

FIG. 13 is a view illustrating the state of the timing T2 to T3.

As understood based on the superimposition process performed on the RAW image described with reference to FIGS. 6 to 10 and the superimposition process performed on the full-color image described with reference to FIGS. 11 to 13, the superimposition process performed on the RAW image and the superimposition process performed on the full-color image are performed using the common superimposition processing unit 200 shown in FIGS. 6 and 11.

Further, in the superimposition processes performed on these different images, two memories which store two images, that is, the memory a 211 and the memory b 212 are used, so that the superimposition process is performed on arbitrary number of images, for example, N images.

### 3. Other Embodiments

Next, other embodiments will be described.

### (3-1) Embodiment in which High Resolution Processing Unit is Established

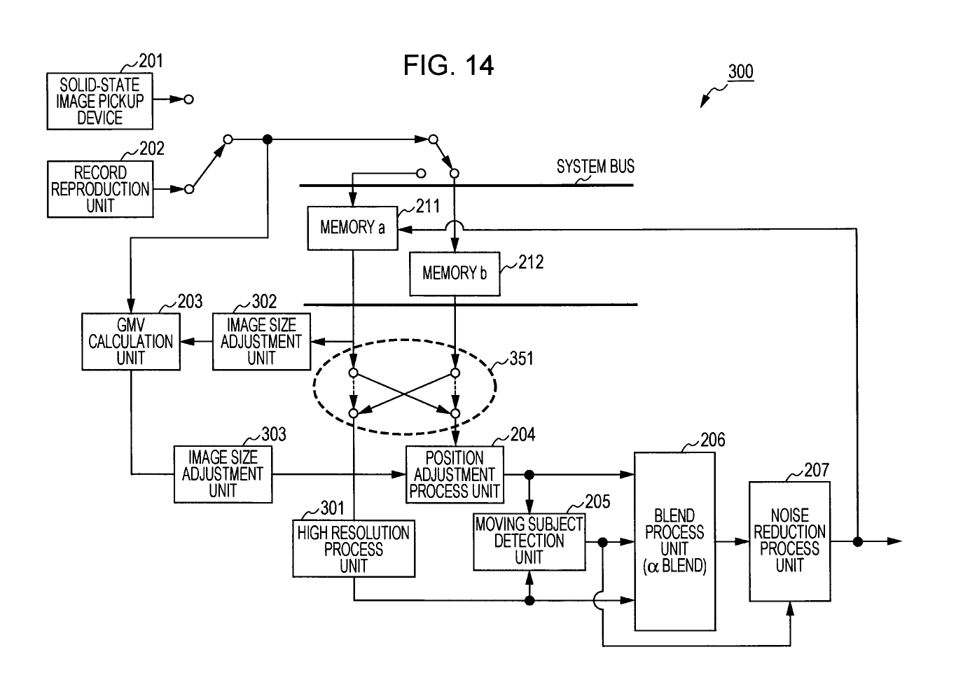

First, an embodiment in which a high resolution processing unit is established in a superimposition processing unit will be described with reference to FIG. 14.

First, a superimposition processing unit 300 shown in FIG. 14 has a configuration in which a high resolution processing unit 301 and image size adjustment units 302 and 303 are added to the superimposition processing unit 200 which was described with reference to FIGS. 6 and 11. The configuration corresponds to the common circuit configuration used as the superimposition processing unit a 105 and the superimposition processing unit b 108 shown in FIG. 1. However, when the superimposition processing unit 300 is used as the superimposition processing unit a 105 relevant to a still image, setting is made such that the configuration of the connection of a wire connection unit 351 is the same as that described with reference to FIG. 6 (the dotted lines of the wire connection unit 351 in FIG. 14). Further, when the superimposition processing unit 300 is used as the superimposition processing unit b 108 relevant to a motion image, setting is made such that the configuration of the connection of a wire connection unit 351 is the same as that described with reference to FIG. 11 (the solid lines of the wire connection unit 351 in FIG. 14).

Further, with respect to an input image, when the superimposition processing unit 300 is used as the superimposition processing unit a 105 corresponding to a still image, a setting is made such that input is performed from the solid-state imaging device 201. When the superimposition processing unit 300 is used as the superimposition processing unit b 108 corresponding to a motion image, configuration is changed such that input is performed from the record reproduction unit 202. This configuration is realized by turning on or off the switches established in the wire connection unit 351 and in the connection unit of the solid-state imaging device 201 and the record reproduction unit 202.

The high resolution processing unit 301 performs resolution conversion. An up-sample unit 11 performs resolution conversion by applying a method of generating an enlarged image using, for example, a process of setting a single pixel to four pixels.

The image size adjustment unit 302 performs a process of adjusting the size of the input image from the memory a 211 into the size of the input image from the record reproduction unit 202, which is the GMV calculation target of the GMV calculation unit 203. An image may be expanded when the high resolution processing unit 301 performs the high resolution process. This process is the process of adjusting the size of the expanded image into the size of the input image from the record reproduction unit 202, which is the GMV calculation target of the GMV calculation unit 203.

The image size adjustment unit 303 performs a process of adjusting the sizes of two images in order to perform the position adjustment on the images, which is performed in the subsequent process.

The sequence performed in the present embodiment is as follows.

In the process performed on the RAW image, the high resolution process is performed between steps S103 and S104 while the process according to the above-described flowchart with reference to FIG. 3 is used as a basic process. Further, setting is made such that the image size adjustment process is performed on the previous step of each step as necessary.

Further, in the process performed on the full-color image, the high resolution process is performed between steps S203 and S204 while the process according to the above-described flowchart with reference to FIG. 5 is used as a basic process. Further, setting is made such that the image size adjustment process is performed on the previous step of each step as necessary.

In the present embodiment, a superimposition process is performed after the high resolution process is performed on the input frame. Therefore, the roughness of edge portions, generated due to the enlargement, can be reduced. Meanwhile, the GMV obtained by the GMV calculation unit 203 is converted into the motion amount of a high resolution image, and then used.

Further, as the modification of the present embodiment, a configuration in which a High Pass Filter (HPF), such as a Laplacian filter, is applied to the input frame may be used in order to compensate the blurring generated due to the high resolution.

### (3-2) Embodiment in which GMV, Calculated when Superimposition Process is Performed on RAW Image, is Used for Superimposition Process Performed on Full-Color Image

Next, an embodiment in which the GMV, calculated when the superimposition process is performed on RAW image, is used for the superimposition process performed on the full-color image will be described.

The above-described embodiment has the configuration in which the GMV calculation is successively performed in the superimposition process of the RAW image and the GMV calculation process is successively performed in the superimposition process of the full-color image.

However, if the full-color image is generated based on the RAW image and the pair of two images which are the GMV calculation targets are the same, the GMV calculated based on the RAW image is the same as the GMV calculated based on the full-color image. Therefore, if, for example, the GMV, calculated in the superimposition process of the RAW image when an image is photographed, is recorded in a memory as data corresponding to each image, GMV data can be obtained when the superimposition process is performed on the full-color image, and it is not necessary to perform the process of calculating a new GMV, so that the process is simplified, thereby rapidly processing the process.

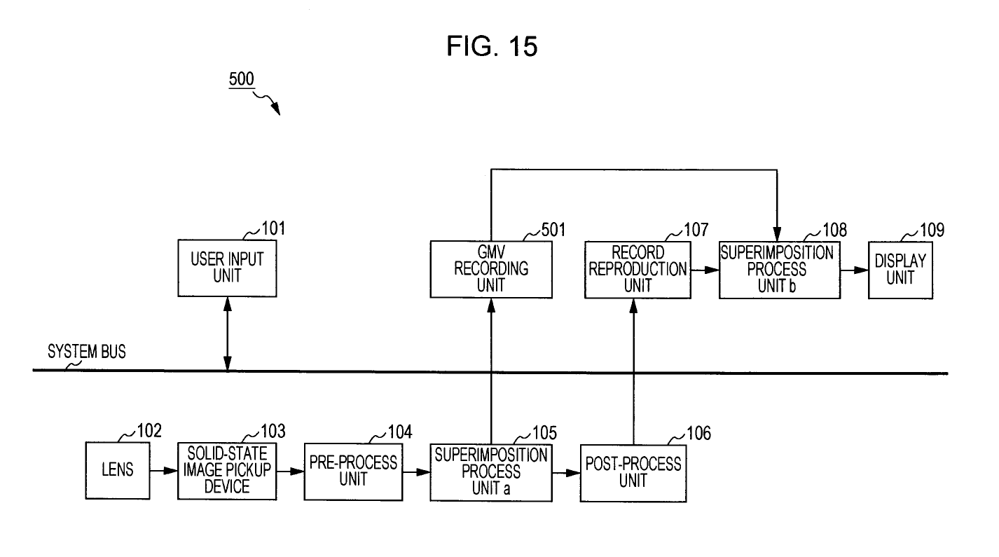

FIG. 15 illustrates an example of the configuration of an image processing apparatus which performs the process.

FIG. 15 illustrates an example of the configuration of an imaging apparatus 500 which is an example of the image processing apparatus according to the present disclosure. The imaging apparatus 500 is the same as the image processing apparatus 100 shown in FIG. 1 which was described above, and performs an image superimposition process on a RAW image captured when an image is photographed and a full-color image generated based on the RAW image in order to realize noise reduction and high resolution.

The superimposition processing unit a 105 of the imaging apparatus 500 shown in FIG. 15 performs the superimposition process on the RAW image. The superimposition processing unit b 108 of the imaging apparatus 500 shown in FIG. 15 performs the superimposition process on the full-color image. Although the superimposition processing unit a 105 and the superimposition processing unit b 108 are illustrated as two blocks, they are configured using a common circuit as described above.

The difference between the image processing apparatus 100 described with reference to FIG. 1 and the image processing apparatus 500 is the fact that the image processing apparatus 500 shown in FIG. 15 includes a GMV recording unit 501.

The GMV recording unit 501 is a recording unit (memory) which records a GMV calculated when the superimposition processing unit a 105 performs the superimposition process on the RAW image. The superimposition processing unit b 108, which performs the superimposition process on the full-color image, uses the GMV recorded in the GMV recording unit 501 without performing the GMV calculation.

GMV data is stored in the GMV recording unit 501 in association with the two pieces of identifier information of the image frames used for the GMV calculation. The superimposition processing unit b 108, which performs the superimposition process on the full-color image, selects the GMV recorded in the GMV recording unit 501 based on the identifiers of the pair of images which are the GMV calculation targets, and uses the selected GMV.

According to the embodiment, when the superimposition process is performed on the full-color image, the GMV data can be obtained, and the process of calculating a new GMV is not necessary, so that the process is simplified, thereby enabling the process to be fast processed. Further, an image, obtained before a codec is used, is used, so that there is an advantage of improving the accuracy of the GMV.

### 4. Example of Hardware Configuration Used for Image Processing Apparatus

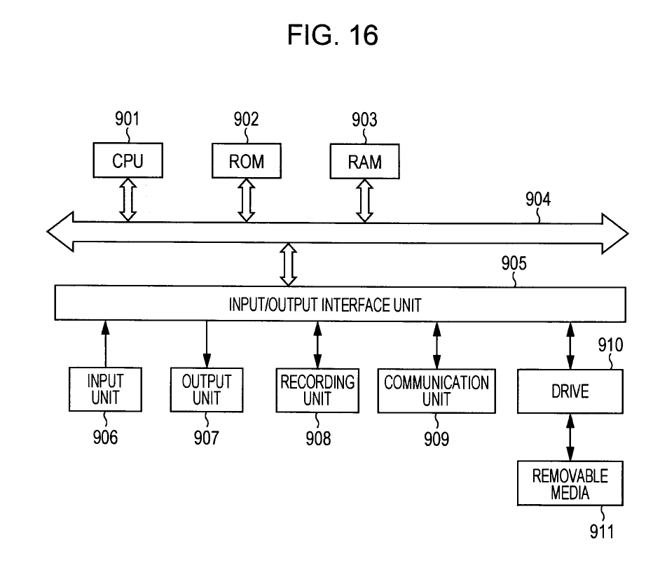

Finally, an example of the hardware configuration of the image processing apparatus which performs the above-described processes will be described with reference to FIG. 16. A Central Processing Unit (CPU) 901 performs the various types of processes based on a program recorded in a Read Only Memory (ROM) 902 or a recording unit 908. For example, the CPU 901 performs the image processes for the image superimposition (blend) process described in above-described each embodiment and the noise reduction and high resolution using a Low Pass Filter (LPF). A Random Access Memory (RAM) 903 appropriately stores programs or data executed by the CPU 901. The CPU 901, the ROM 902, and the RAM 903 are connected to each other via a bus 904.

The CPU 901 is connected to an input/output interface 905 via the bus 904. An input unit 906, including a keyboard, a mouse, a microphone or the like, and an output unit 907, including a display, a speaker or the like, are connected to the input/output interface 905. The CPU 901 executes various types of processes based on instructions input from the input unit 906, and outputs the results of the process to the output unit 907.

The recording unit 908 which is connected to the input/output interface 905 includes, for example, a hard disk, and stores programs and various types of data which are executed by the CPU 901. A communication unit 909 communicates with external apparatuses via a network, such as the Internet or a local area network.

A drive 910 which is connected to the input/output interface 905 drives a removable media 911, such as a magnetic disk, an optical disc, a magneto-optical disc, a semiconductor memory or the like, and obtains a recorded program or data. The obtained program or data is transmitted to the recording unit 908 and recorded as necessary.

### 5. Arrangement of Configuration of Present Disclosure

Hereinbefore, the embodiments of the present disclosure have been described in detail with reference to specific embodiments. However, it is apparent for those skilled in the art that the modifications and substitutions of the embodiment may occur without departing from the gist of the present disclosure. That is, the present disclosure has been disclosed in the form of exemplification, and should not be limitedly interpreted. In order to determine the gist of the present disclosure, reference should be made to the scope of the claims.

Meanwhile, the technology disclosed in the present specification can include the following configurations.

(1) An image processing apparatus includes a superimposition processing unit which performs a blend process on a plurality of images which are continuously photographed. The superimposition processing unit includes a moving subject detection unit which detects the moving subject region of an image, and generates moving subject information in units of an image region; a blend processing unit which generates a superimposition image by performing a blend process on the plurality of images using a high blend ratio in a stationary subject region and using a low blend ratio in the moving subject region based on the moving subject information; and a noise reduction processing unit which performs a stronger pixel value smoothing process on the moving subject region of the superimposition image based on the moving subject information.

(2) In the image processing apparatus of (1), the noise reduction processing unit performs a pixel value updating process which performs a low-pass filter process.

(3) In the image processing apparatus of (1) or (2), the noise reduction processing unit performs a pixel value updating process which performs a low-pass filter process having coefficients depending on the moving subject information which enables higher noise reduction effect to be obtained in the moving subject region.

(4) In the image processing apparatus any of (1) to (3), the superimposition processing unit includes a GMV calculation unit which calculates a GMV of the plurality of images which are continuously photographed, and a position adjustment processing unit which generates a motion-compensated image by adjusting the subject position of a reference image into a position of a standard image based on the GMV. The moving subject detection unit obtains the moving subject information based on the pixel difference of corresponding pixels between the motion-compensated image, obtained as a result of the position adjustment performed by the position adjustment processing unit, and the standard image. The blend processing unit generates the superimposition image by blending the standard image and the motion-compensated image according to a blend ratio based on the moving subject information.

(5) In the image processing apparatus of (4), the moving subject detection unit calculates the value α indicative of the moving subject information as the moving subject information in units of a pixel based on the pixel difference of the corresponding pixels between the motion-compensated image, obtained as the result of the position adjustment performed by the position adjustment processing unit, and the standard image. The blend processing unit performs the blend process of setting the blend ratio of the motion-compensated image to be a low value with respect to a pixel which has the high possibility of being a moving subject and setting the blend ratio of the motion-compensated image to be a high value with respect to a pixel which has the low possibility of being the moving subject based on the value α.

(6) In the image processing apparatus of (4) or (5), the superimposition processing unit includes a high resolution processing unit which performs a high resolution process on a process target image, and the blend processing unit superimposes high-resolution processed images using the high resolution processing unit.

(7) In the image processing apparatus of any of (4) to (6), the image processing apparatus further includes a GMV recording unit which stores the GMV of an image, which was calculated by the GMV calculation unit based on the RAW image, wherein the superimposition processing unit performs the superimposition process on the full-color image used as a process target using the GMV stored in the GMV recording unit.

(8) In the image processing apparatus of any of (1) to (7), the superimposition processing unit is configured to perform a superimposition process by selectively inputting the RAW image or the brightness signal information of the full-color image as a process target image, and is configured to perform a process of enabling an arbitrary number of image superimposition to be performed by sequentially updating data to be stored in a memory which stores two image frames.

(9) In the image processing apparatus of (8), the superimposition processing unit performs a process of overwriting and storing an image, obtained after the superimposition process is performed, in a part of the memory, and uses the superimposition processed image stored in the corresponding memory for a subsequent superimposition process.

(10) In the image processing apparatus of (8) or (9), when the RAW image is used as the process target, the superimposition processing unit stores pixel value data corresponding to each pixel of the RAW image in the memory and performs the superimposition process based on the pixel value data corresponding to each pixel of the RAW image. When a full-color image is used as the process target, the superimposition processing unit stores brightness value data corresponding to each pixel in the memory and performs the superimposition process based on the brightness value data corresponding to each pixel of the full-color image.

Further, a series of processes described in the specification can be performed using hardware, software, or the composite configuration thereof. When a process is performed using software, the process can be performed by installing a program which records the sequence of the process in a memory of a computer, which is embedded in dedicated hardware, or can be performed by installing the program in a general-purpose computer capable of performing various types of processes. For example, the program can be recorded in a recording medium in advance. In addition to the installation in a computer from a recording medium, the program can be received via a network, called a Local Area Network (LAN) or the Internet, and can be installed in the recording medium, such as a built-in hard disk or the like.

Meanwhile, the various types of processes written in the specification may be parallelly or individually performed according to the process capacity of an apparatus which performs the processes or as necessary, in addition to be performed in time series as being written. Further, a system in the present specification is a logical collective configuration of a plurality of apparatuses, and the apparatuses of each configuration are not limited to be included in the same case.

The present disclosure contains subject matter related to that disclosed in Japanese Priority Patent Application JP 2011-047360 filed in the Japan Patent Office on Mar. 4, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
a superimposition processing unit which performs a blend process on a plurality of images which are continuously photographed,
wherein the superimposition processing unit includes:
a moving subject detection unit which detects a moving subject region of an image, and generates moving subject information in units of an image region;
a blend processing unit which generates a superimposition image by performing a blend process on the plurality of images using a high blend ratio in a stationary subject region and using a low blend ratio in the moving subject region based on the moving subject information; and
a noise reduction processing unit which performs a stronger pixel value smoothing process on the moving subject region of the superimposition image based on the moving subject information.

2. The image processing apparatus according to claim 1,
wherein the noise reduction processing unit performs a pixel value updating process which performs a low-pass filter process.

3. The image processing apparatus according to claim 1,
wherein the noise reduction processing unit performs a pixel value updating process which performs a low-pass filter process having coefficients depending on the moving subject information which enables higher noise reduction effect to be obtained in the moving subject region.

4. The image processing apparatus according to claim 1,
wherein the superimposition processing unit includes
a Global Motion Vector (GMV) calculation unit which calculates a Global Motion Vector (GMV) of the plurality of images which are continuously photographed; and
a position adjustment processing unit which generates a motion-compensated image by adjusting a subject position of a reference image into a position of a standard image based on the GMV,
wherein the moving subject detection unit obtains the moving subject information based on a pixel difference of corresponding pixels between the motion-compensated image, obtained as a result of the position adjustment performed by the position adjustment processing unit, and the standard image, and
wherein the blend processing unit generates the superimposition image by blending the standard image and the motion-compensated image according to a blend ratio based on the moving subject information.

5. The image processing apparatus according to claim 4,
wherein the moving subject detection unit calculates a value α indicative of the moving subject information as the moving subject information in units of a pixel based on the pixel difference of the corresponding pixels between the motion-compensated image, obtained as the result of the position adjustment performed by the position adjustment processing unit, and the standard image, and
wherein the blend processing unit performs the blend process of setting the blend ratio of the motion-compensated image to be a low value with respect to a pixel which has a high possibility of being a moving subject and setting the blend ratio of the motion-compensated image to be a high value with respect to a pixel which has a low possibility of being the moving subject based on the value α.

6. The image processing apparatus according to claim 4,
wherein the superimposition processing unit includes
a high resolution processing unit which performs a high resolution process on a process target image, and
wherein the blend processing unit superimposes high-resolution processed images using the high resolution processing unit.

7. The image processing apparatus according to claim 4, further comprising:
a GMV recording unit which stores the GMV of an image, which was calculated by the GMV calculation unit based on a RAW image,
wherein the superimposition processing unit performs the superimposition process on a full-color image used as a process target using the GMV stored in the GMV recording unit.

8. The image processing apparatus according to claim 1,
wherein the superimposition processing unit is configured to perform a superimposition process by selectively inputting a RAW image or brightness signal information of the full-color image as a process target image, and is configured to perform a process of enabling an arbitrary number of image superimposition to be performed by sequentially updating data to be stored in a memory which stores two image frames.

9. The image processing apparatus according to claim 8,
wherein the superimposition processing unit performs a process of overwriting and storing an image, obtained after the superimposition process is performed, in a part of the memory, and uses the superimposition processed image stored in the corresponding memory for a subsequent superimposition process.

10. The image processing apparatus according to claim 8,
wherein the superimposition processing unit, when the RAW image is used as the process target, stores pixel value data corresponding to each pixel of the RAW image in the memory and performs the superimposition process based on the pixel value data corresponding to each pixel of the RAW image, and, when the full-color image is used as the process target, stores brightness value data corresponding to each pixel in the memory and performs the superimposition process based on the brightness value data corresponding to each pixel of the full-color image.

11. An image processing method executed by an image processing apparatus, the image processing method comprising:
performing a blend process on a plurality of images which are continuously photographed using a superimposition processing unit,
wherein the performing the blend process includes:
a moving subject detection process of detecting a moving subject region in an image and generating moving subject information in units of an image region;
a blend process of generating a superimposition image by performing the blend process on the plurality of images using a high blend ratio in a stationary subject region and using a low blend ratio in the moving subject region based on the moving subject information; and
a noise reduction process of performing a stronger pixel value smoothing process on the moving subject region of the superimposition image based on the moving subject information.

12. A program causing an image processing apparatus to perform an image process, the program causing a superimposition processing unit to perform a blend process on a plurality of images which are continuously photographed,
wherein the performing the blend process includes:
a moving subject detection process of detecting a moving subject region of an image and generating moving subject information in units of an image region;
a blend process of generating a superimposition image by performing the blend process on the plurality of images using a high blend ratio in a stationary subject region and using a low blend ratio in the moving subject region based on the moving subject information; and
a noise reduction process of performing a stronger pixel value smoothing process on the moving subject region of the superimposition image based on the moving subject information.
